(19) United States
(12) Patent Application Publication
(10) Pub. No.: US 2013/0149138 A1
(43) Pub. Date: Jun. 13, 2013

(54) FASTENING APPARATUS FOR FAN

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/426,628

(22) Filed: Mar. 22, 2012

(30) Foreign Application Priority Data
Dec. 8, 2011 (CN) 201110405851.0

(51) Int. Cl. F04D 29/64; F16M 13/00

(52) U.S. Cl. 415/213.1; 248/674

(57) ABSTRACT

A fastening apparatus for fastening a fan having two boards includes a bottom plate, four fastening bases, two fastening members, two receiving members, two locking members, and two elastic members. The fastening bases are fastened to the bottom plate. Each fastening base defines a through hole. Each fastening member includes a mounting pole extending through two mounting holes defined in one of the boards and then engaging in the through holes of two of the fastening bases. The receiving members engage with the fastening members. Each locking member is attached to the fastening member and the receiving member. Each locking member includes a fastening pole. The elastic members are sandwiched between the locking members and fastening members to make the fastening poles extend through the receiving members and the two mounting holes of the other board and then engage in the through holes of the remaining fastening bases.

### BACKGROUND

1. Technical Field

The present disclosure relates to an apparatus for fastening a fan.

2. Description of Related Art

Large electronic devices use fans to cool electronic components installed therein. Fans are usually mounted in the electronic device by a plurality of screws, which makes it difficult and time-consuming to replace or remove the fans for repairing.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a fastening apparatus together with a fan, wherein the fastening device includes two receiving members and two fastening members.

FIG. 2 is an enlarged view of one of the receiving members of FIG. 1, but viewed from a different perspective.

FIG. 3 is an enlarged view of one of the fastening members of FIG. 1

FIG. 4 is an assembled, isometric view of FIG. 1.

FIG. 5 is a cross-sectional view taken along the line of V-V of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

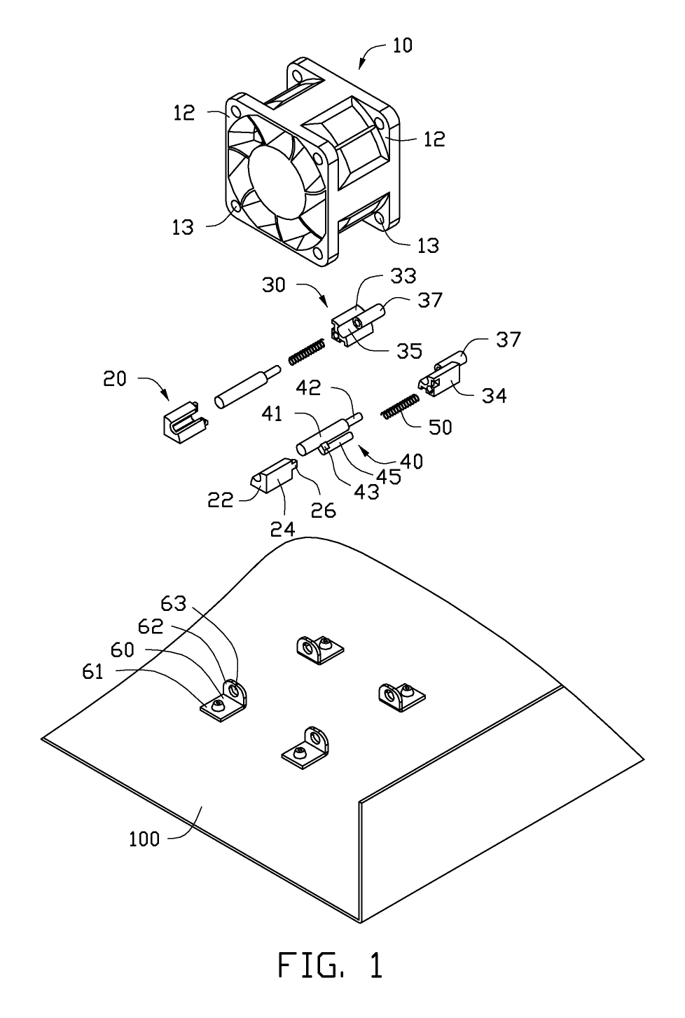

FIG. 1 shows an exemplary embodiment of a fastening apparatus for fastening a fan 10 to a bottom plate 100 including two receiving members 20, two fastening members 30, two locking members 40, and two elastic members such as two springs 50. The fan 10 has a flat front-facing surface and a flat rear-facing surface (together referred to as spaced boards 12). Two mounting holes 13 are defined in opposite ends of a bottom of each board 12.

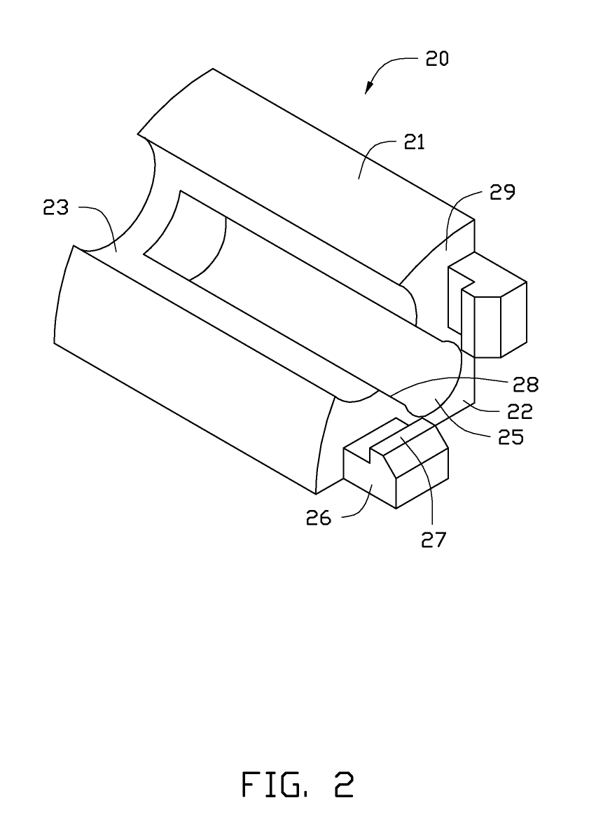

FIG. 2 shows each receiving member 20 including a main body 22 with a fan-shaped cross-section, and two hooks 26 protruding from a first end 29 surface of the main body 22. The main body 22 includes a curved first sidewall 21 and two flat second sidewalls 24 perpendicularly connected to each other and adjoining opposite sides of the first sidewall 21. The first sidewall 21 longitudinally defines an arc-shaped first slide slot 23 extending through the first end surface 29 and a second end surface opposite to the first end surface 29, and parallel to a junction of the second sidewalls 24. A cylinder-shaped second slide slot 25 is longitudinally defined in the main body 22, extending through the first end surface 29. A communicating slot 28 is defined in the main body 22, communicating with the first slide slot 23 and the second slide slot 25. The hooks 26 substantially perpendicularly extend from the first end surface 29, adjoining the corresponding second sidewalls 24. Each hook 26 includes a latching portion 27 extending away from the corresponding second sidewall 24 from a distal end of the hook 26.

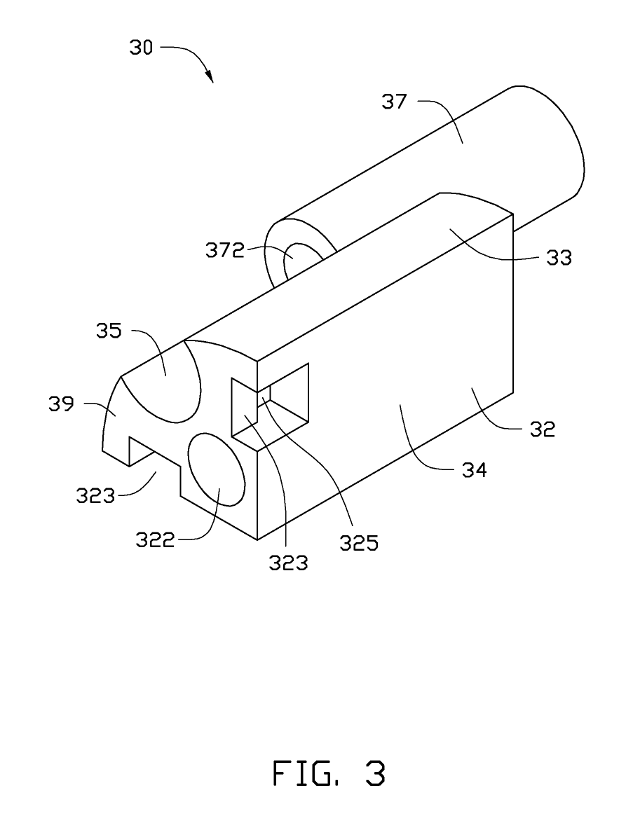

FIG. 3 shows each fastening member 30 including a mounting portion 32 with a fan-shaped cross-section, and a mounting pole 37. The mounting portion 32 includes a curved first sidewall 33, and two flat second sidewalls 34 substantially perpendicularly connected to each other and adjoining opposite sides of the first sidewall 33. The first sidewall 33 longitudinally defines an arc-shaped third slide slot 35 extending through a first end surface 39 and a second end surface opposite to the first end surface 39, and parallel to a junction of the second sidewalls 34. The mounting pole 37 is partly received in the third slide slot 35 and extended out of the second end surface of the mounting portion 32. A guiding hole 372 is axially defined in an end of the mounting pole 37 adjacent to the first end surface 39. A hole 322 is defined in the first end surface 39. Two grooves 323 are defined in the corresponding second sidewalls 34, extending through the first end surface 39. A hooking slot 325 is defined in the bottom wall of each groove 323, away from the first end surface 39.

FIG. 1 shows each locking member 40 including a large fastening pole 41 and a small guiding pole 42 extending from a first end of the fastening pole 41. A stop portion 43 protrudes from a middle of a circumference of the fastening pole 41. A pole 45 extends from a distal end of the stop portion 43 toward the first end of the fastening pole 41.

Four fastening bases 60 are fastened to the bottom plate 100, arranged in two rows. Each fastening base 60 includes a fastening portion 61 fastened to the bottom plate 100 and a mounting tab 62 perpendicularly extending up from an end of the fastening portion 61 adjacent to the other row of fastening bases 60. A through hole 63 is defined in each mounting tab 62.

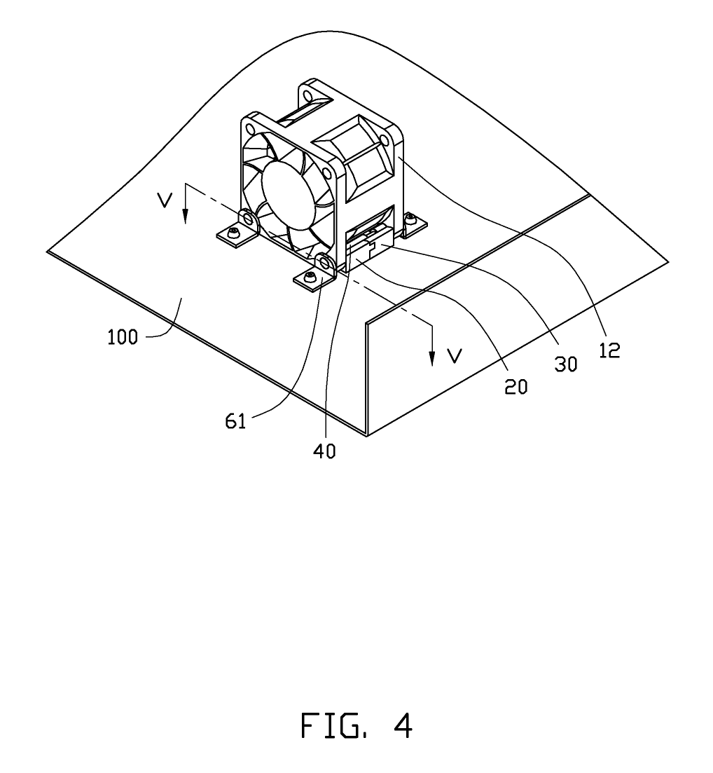

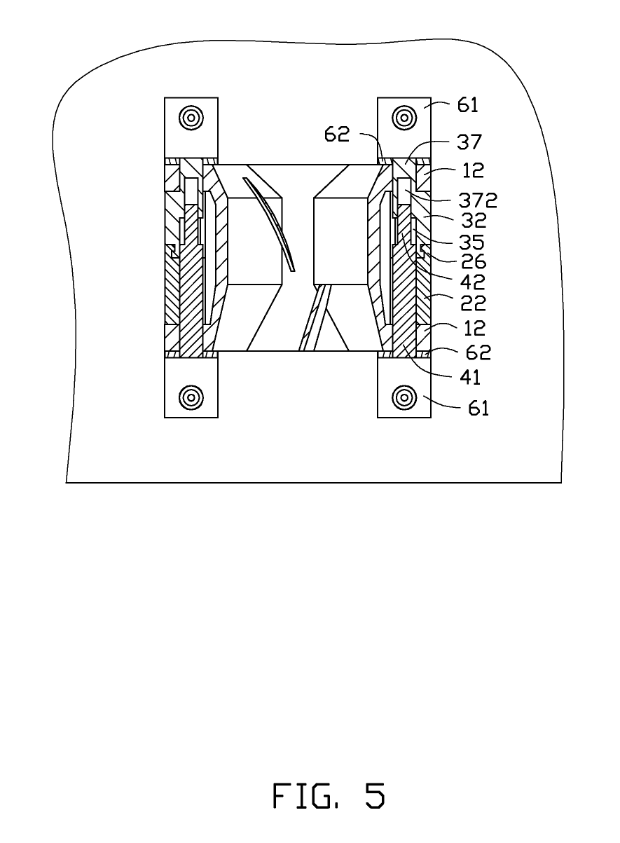

FIGS. 4 and 5 show the assembly of the fastening apparatus. The springs 50 are placed around the corresponding poles 45. Second ends of the fastening poles 41 are received in the corresponding first slide slots 23 through the first end surfaces 29. The stop portions 43 are received in the corresponding communicating slots 28. The poles 45 with the springs 50 are received in the corresponding second slide slots 25. The first ends of the fastening poles 41 and the poles 45 extend out of the corresponding receiving members 20. The guiding poles 42 extend through the corresponding third slide slots 35, and then engage in the corresponding guiding holes 372. The poles 45 together with the springs 50 engage in the corresponding holes 322. The fastening poles 41 engage in the corresponding third slide slots 35. The latching portions 27 engage in the corresponding hooking slots 325, to allow the receiving members 20 to be fastened to the corresponding fastening members 30. Each spring 50 is sandwiched between the corresponding stop portion 43 and the end wall bounding the corresponding hole 322. The springs 50 bias the second ends of the fastening poles 41 to extend out of the corresponding receiving members 20 through the second end surfaces of the receiving members 20.

To mount the fastening apparatus to the fan 10, the fastening poles 41 are manipulated to slide toward the corresponding fastening members 30, the springs 50 are compressed. The mounting poles 37 engage in the corresponding mounting holes 13 of the rear board 12. The fastening poles 41 align with the corresponding mounting holes 13 of the front board 12. The fastening poles 41 are released, the springs 50 are self-restored to bias the second ends of the fastening poles 41 to engage in the corresponding mounting holes 13 of the front board 12. In assembling the fan 10 to the bottom plate 100, the fan 10 is leant back, the mounting poles 37 engage in the through holes 63 of the two rear fastening bases 60. The fastening poles 41 are pushed back to compress the corresponding springs 50. The fan 10 is rotated to abut against the mounting tabs 62 of the two front fastening bases 60. The position of the fan 10 is adjusted to make the fastening poles 41 align with the corresponding through holes 63. The springs 50 are self-restored to bias the fastening poles 41 to engage in the corresponding through holes 63. Therefore, the fan 10 is fastened to the bottom plate 100.

In other embodiments, the receiving members 20 and the fastening members 30 may be rectangular or other shapes. The first slide slots 23 and the third slide slots 35 may be defined in middles of end walls of the receiving members 20 and the fastening members 30. The stop portions 42, the poles 45, and the holes 322 may be omitted, the springs 50 are placed around the corresponding guiding poles 42, to allow the springs 50 to be sandwiched between the fastening poles 41 and the mounting poles 37.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A fastening apparatus for a fan having two spaced boards, comprising:
a fastening member comprising a mounting pole to extend through a first mounting hole defined in one of the boards;
a receiving member engaging with the fastening member;
a locking member slidably attached to the fastening member and receiving member, and comprising a fastening pole; and
an elastic member sandwiched between the locking member and the fastening member, and biasing the fastening pole to extend through the receiving member and a second mounting hole defined in the other board.

2. The fastening apparatus of claim 1, wherein the receiving member comprises a main body, the main body longitudinally defines a first slide slot extending through opposite end surfaces of the main body, the fastening member comprises a mounting portion, the mounting portion longitudinally defines a second slide slot aligning with the first slide slot, the mounting pole extends out of the second slide slot, away from the receiving member, the fastening pole is slidably received in the first slide slot and the second slide slot.

3. The fastening apparatus of claim 2, wherein the locking member further comprises a stop portion extending out from a circumference of the fastening pole and a pole extending from the stop portion toward the fastening member, the elastic member is placed around the pole, the main body longitudinally defines a third slide slot extending through the first end surface of the main body adjacent to the fastening member, the pole together with the elastic member is received in the third slide slot, opposite ends of the elastic member respectively abut against the stop portion and the fastening member.

4. The fastening apparatus of claim 3, wherein the mounting portion defines a hole facing the receiving member, the pole with the elastic member slidably engages in the hole.

5. The fastening apparatus of claim 2, wherein the mounting pole defines a guiding hole facing the locking member, a guiding pole extends from the fastening pole to slidably engage in the guiding hole.

6. The fastening apparatus of claim 2, wherein two hooking slots are defined in the mounting portion, adjacent to the receiving member, two hooks extend from the first end surface of the main body to engage in the corresponding hooking slots.

7. A fan assembly, comprising:
a fan comprising two opposite boards, each board defining a mounting hole;
a fastening member comprising a mounting pole, to extend through the mounting hole of one of the boards;
a receiving member engaging with the fastening member;
a locking member slidably attached to the fastening member and the receiving member, and comprising a fastening pole; and
an elastic member placed between the locking member and the fastening member, and biasing the fastening pole to extend through the receiving member and the mounting hole defined of the other board.

8. The fan assembly of claim 7, wherein the receiving member comprises a main body, the main body longitudinally defines a first slide slot extending through opposite end surfaces of the main body, the fastening member comprises a mounting portion, the mounting portion longitudinally defines a second slide slot aligning with the first slide slot, the mounting pole extends out of the second slide slot, away from the receiving member, the fastening pole is slidably received in the first slide slot and second slide slot.

9. The fan assembly of claim 8, wherein the locking member further comprises a stop portion extending out from a circumference of the fastening pole and a pole extending from the stop portion toward the fastening member, the elastic member is placed around the pole, the main body longitudinally defines a third slide slot extending through the first end surface of the main body adjacent to the fastening member, the pole together with the elastic member is received in the third slide slot, opposite ends of the elastic member respectively abut against the stop portion and the fastening member.

10. The fan assembly of claim 9, wherein the mounting portion defines a hole facing the receiving member, the pole with the elastic member slidably engages in the hole.

11. The fan assembly of claim 8, wherein the mounting pole defines a guiding hole facing the locking member, a guiding pole extends from the fastening pole to slidably engage in the guiding hole.

12. The fan assembly of claim 8, wherein two hooking slots are defined in the mounting portion, adjacent to the receiving member, two hooks extend from the first end surface of the main body to engage in the corresponding hooking slots.

13. An assembly, comprising:
a bottom plate;
two fastening bases fastened to the bottom plate, each fastening base defining a through hole aligning with the through hole of the other fastening base;
a fan comprising two opposite boards, each board defining a mounting hole;
a fastening member comprising a mounting pole, to extend through the mounting hole of one of the boards and then engage in the through hole of a corresponding one of the fastening bases;
a receiving member engaging with the fastening member;
a locking member slidably attached to the fastening member and the receiving member, and comprising a fastening pole; and
an elastic member placed between the locking member and the fastening member, and biasing the fastening pole to extend through the receiving member and the mounting hole of the other board and then engage in the through hole of the other fastening base.

14. The assembly of claim 13, wherein the receiving member comprises a main body, the main body longitudinally defines a first slide slot extending through opposite end surfaces of the main body, the fastening member comprises a mounting portion, the mounting portion longitudinally defines a second slide slot aligning with the first slide slot, the mounting pole extends out of the second slide slot, away from the receiving member, the fastening pole is slidably received in the first slide slot and second slide slot.

15. The assembly of claim 14, wherein the locking member further comprises a stop portion extending out from a circumference of the fastening pole and a pole extending from the stop portion toward the fastening member, the elastic member is placed around the pole, the main body longitudinally defines a third slide slot extending through the first end surface of the main body adjacent to the fastening member, the pole together with the elastic member is received in the third slide slot, opposite ends of the elastic member respectively abut against the stop portion and the fastening member.

16. The assembly of claim 15, wherein the mounting portion defines a hole facing the receiving member, the pole with the elastic member slidably engages in the hole.

17. The assembly of claim 14, wherein the mounting pole defines a guiding hole facing the locking member, a guiding pole extends from the fastening pole to slidably engage in the guiding hole.

18. The assembly of claim 14, wherein two hooking slots are defined in the mounting portion, adjacent to the receiving member, two hooks extend from the first end surface of the main body to engage in the corresponding hooking slots.

19. The assembly of claim 13, wherein each fastening base comprises a fastening portion fastened to the bottom plate and a mounting tab extending up from an end of the fastening portion adjacent to the other fastening base, the through holes are respectively defined in the mounting tabs.
